(19) United States
(12) Patent Application Publication
(10) Pub. No.: US 2026/0323431 A1
(43) Pub. Date: Oct. 15, 2026

(54) UE SPECIFIC CELL INFORMATION INDICATION

(71) Applicant: QUALCOMM Incorporated, San Diego, CA (US)

(72) Inventors: Igor GUTMAN, Hod HaSharon (IL); Navid ABEDINI, Basking Ridge, NJ (US); Jelena DAMNJANOVIC, Del Mar, CA (US); Junyi LI, Greentown, PA (US); Narayan PRASAD, Westfield, NJ (US); Tao LUO, San Diego, CA (US)

(21) Appl. No.: 19/179,957

(22) Filed: Apr. 15, 2025

(51) Int. Cl. H04W 36/00; H04W 36/08

(52) U.S. Cl. CPC H04W 36/0085; H04W 36/08

(57) ABSTRACT

Certain aspects of the present disclosure provide techniques for gathering and sharing UE-specific cell information. According to certain aspects, a user equipment (UE), while operating in a first network, transmits a request for a report regarding one or more metrics (e.g., quality indicators (QIs)) associated with at least a second network, wherein the one or more metrics are based on observations by a wireless node operating in the second network. The UE receives the report, including at least one of the one or more metrics, and makes a cell selection or a cell reselection decision using the report.

### FIELD OF THE DISCLOSURE

Aspects of the present disclosure relate to wireless communications, and more particularly, to techniques for gathering and sharing UE-specific cell information.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a first wireless node. The method includes outputting, while operating in a first network, a request for a report regarding one or more metrics associated with at least a second network, wherein the one or more metrics are based on observations by a second wireless node operating in the second network; obtaining the report including at least one of the one or more metrics; and making a cell selection or a cell reselection decision using the report.

Another aspect provides a method for wireless communication at a first wireless node. The method includes obtaining, while operating in a second network, a request for a report regarding one or more metrics associated with the second network, wherein the one or more metrics are based on observations by the first wireless node; and outputting the report including at least one of the one or more metrics.

Another aspect provides a method for wireless communication (e.g., at a server). The method includes obtaining, from a first wireless node operating in a first network, a request for a report regarding one or more metrics associated with a second network, wherein the one or more metrics are based on observations by a second wireless node; and outputting the report including at least one of the one or more metrics.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example scenario with a pre-configured candidate cell set.

FIG. 6 depicts an example of UE mobility.

FIG. 7 depicts an example cell switch command medium access control (MAC) control element (CE) random access channel (RACH) procedure.

FIG. 8 depicts an example scenario in which techniques for UE-specific cell information indication may be used, in accordance with certain aspects of the present disclosure.

FIG. 9 depicts a call flow diagram illustrating example techniques for UE-specific cell information indication, in accordance with certain aspects of the present disclosure.

FIG. 10 depicts a diagram illustrating example techniques for UE-specific cell information indication, in accordance with certain aspects of the present disclosure.

FIG. 11 depicts a diagram illustrating example sidelink techniques for UE-specific cell information indication, in accordance with certain aspects of the present disclosure.

FIG. 12 depicts a method for wireless communications.

FIG. 13 depicts a method for wireless communications.

FIG. 14 depicts a method for wireless communications.

FIG. 15 depicts aspects of an example communications device.

### DETAILED DESCRIPTION

Aspects of the present disclosure relate to wireless communications, and more particularly, to techniques for gathering and sharing UE-specific cell information.

In certain wireless communications systems, mobility procedures are in place to help maintain network connections for a user equipment (UE) as it moves between the coverage areas of different cells. Mobility procedures generally refer to mechanisms that allow a UE to transition from being served by a source cell to being served by a target cell. Cell selection/reselection techniques are important aspects of mobility procedures.

In some cases, UEs that are at the same geo-location may be connected to different networks and may experience different levels of service. For example, one UE may experience better service than a nearby UE for various reasons such as different distances of the UEs to their respective NW (e.g., base station), different densities of base stations, differing support for advanced features, different levels of interference from other cells, or different levels of observed latency/delays.

Aspects of the present disclosure, provide techniques that may enable UEs operating on same or different networks to share information about the connection quality observed by the UEs in their own network, as captured in metrics referred to herein as quality indicators (QIs). A UE may use this shared information (e.g., a list of QIs) for inter-network cell selection and reselection decisions (e.g., to switch between cells in different networks) and/or intra-network cell selection and reselection decisions (e.g., to switch between cells in the same network).

Techniques disclosed herein may, thus, leverage various statistics in the form quality indicators (QIs) gathered and shared between UEs on different networks to improve inter-network and/or intra-network cell selection and/or reselection decisions which may improve quality of service (QoS) and quality of experience (QoE).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

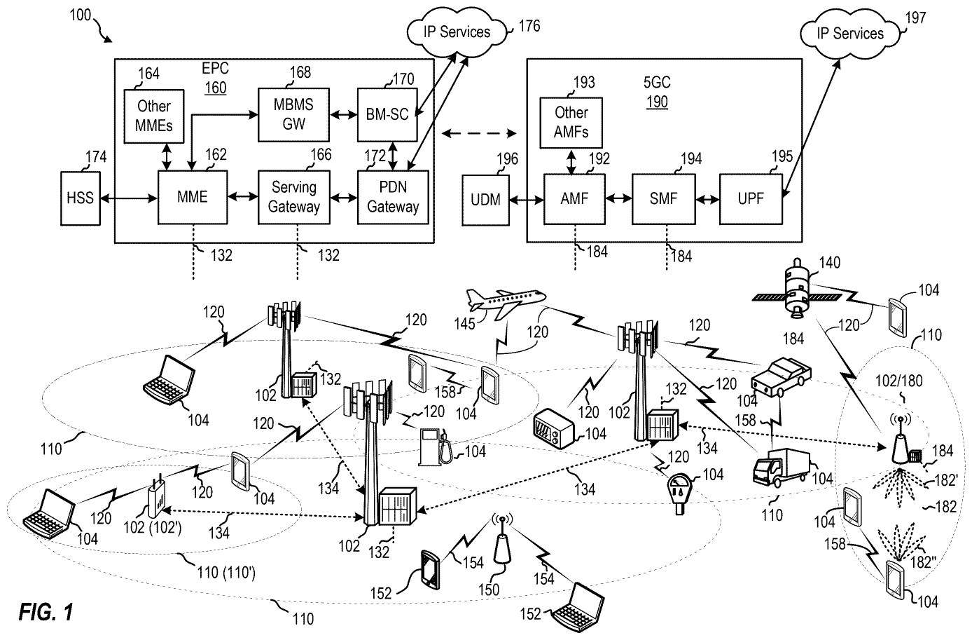

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

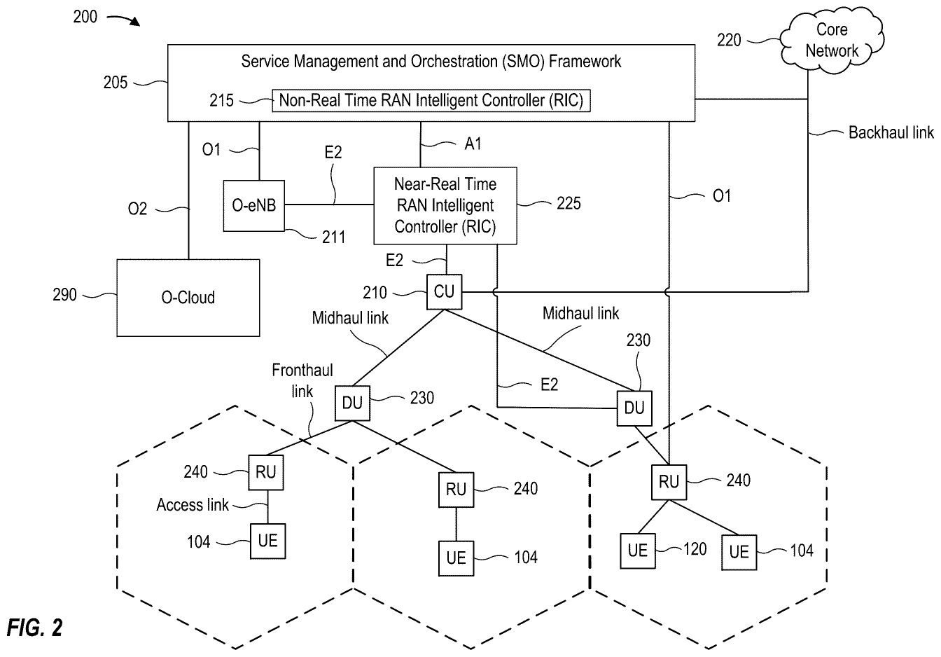

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

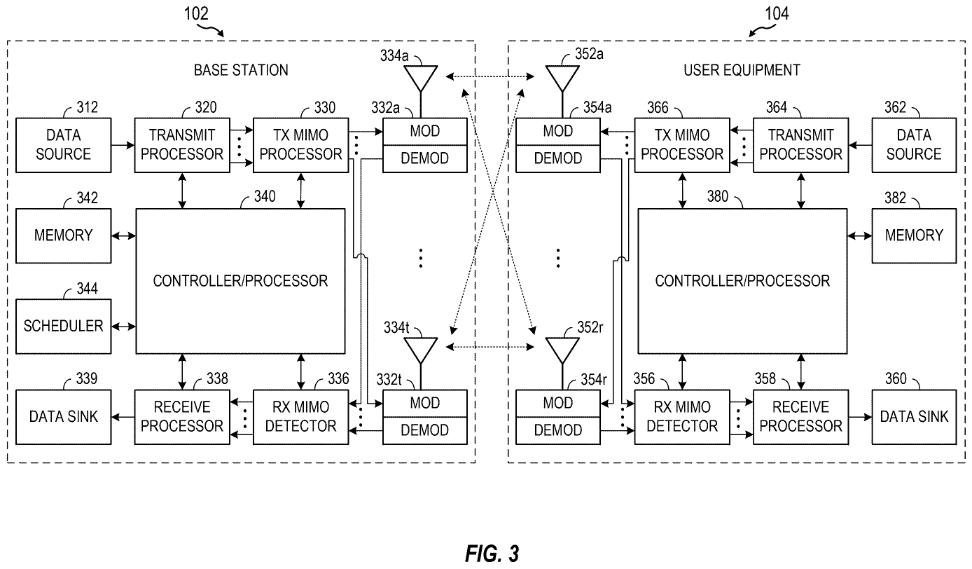

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

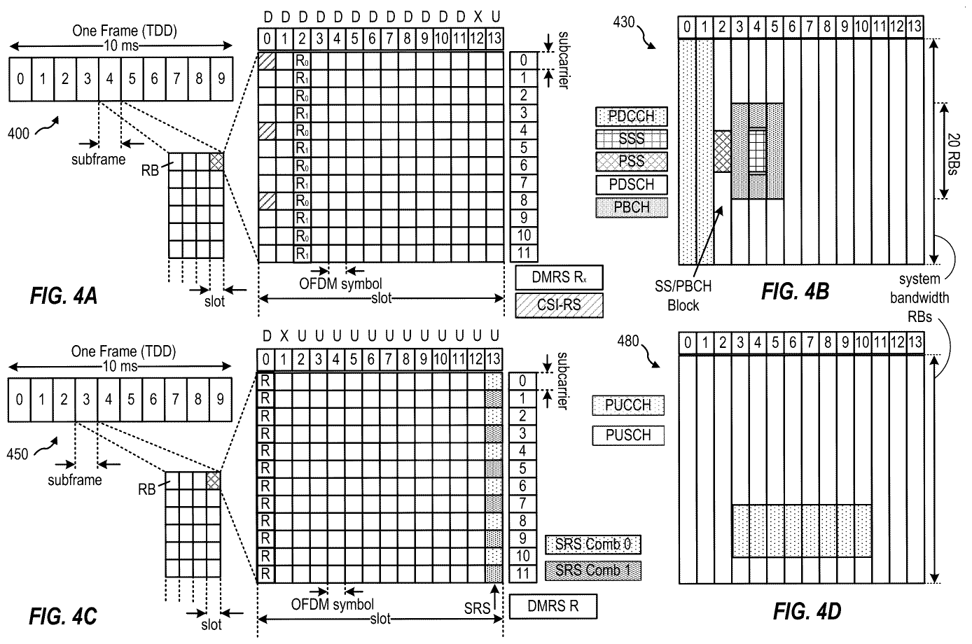

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

PRACH triggering from a network entity may be based on higher layer signaling (e.g., RRC) or, in some cases, lower layer signaling such as a physical downlink control channel (PDCCH). In some cases, PRACH transmissions for uplink (UL) timing in a candidate cell may be triggered via a downlink control information (DCI) from a serving cell.

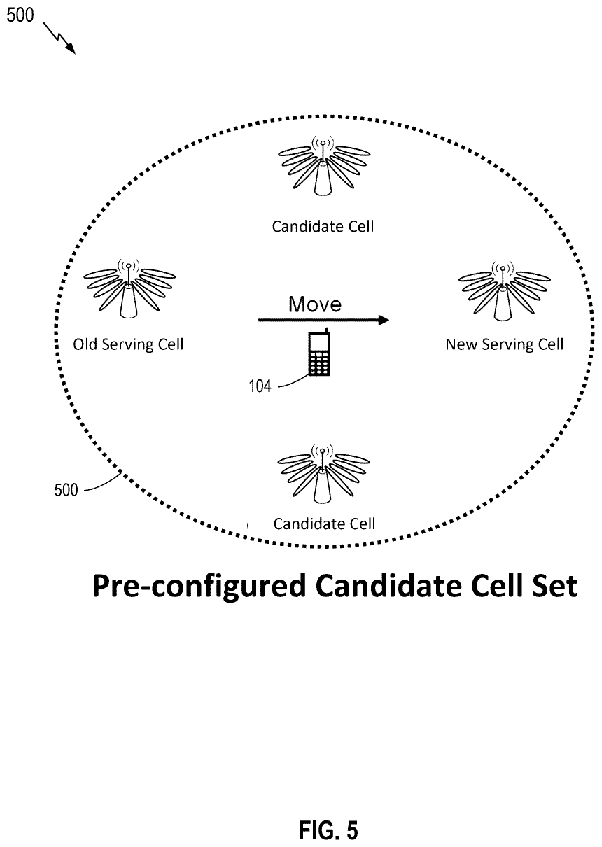

Triggering PRACH transmissions may be beneficial in the scenario illustrated in FIG. 5, where a UE may move between a preconfigured set 500 of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

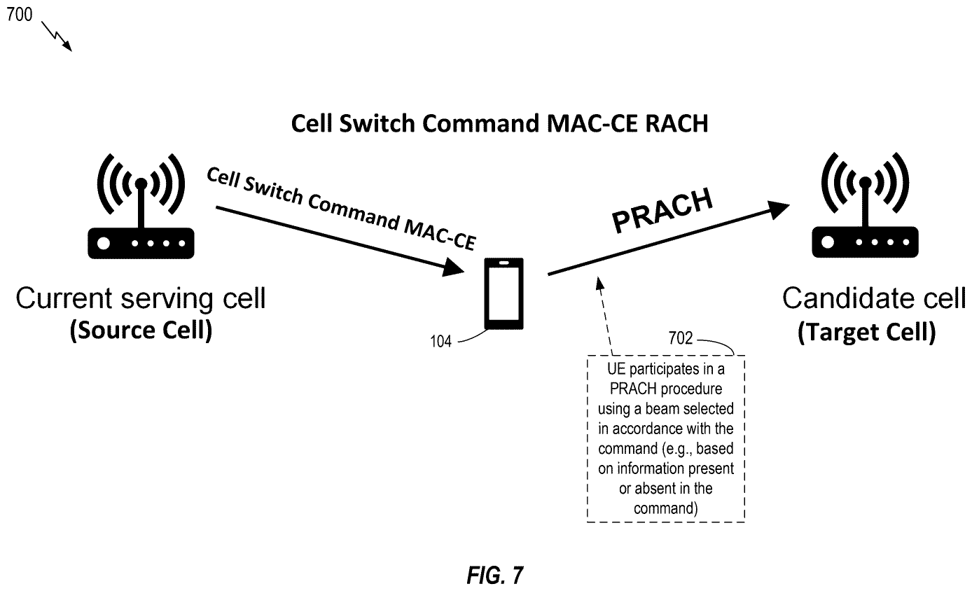

As will be described in greater detail below, with reference to FIG. 7, a RACH may be triggered via a cell switch command MAC-CE. The cell switch command MAC-CE may be sent by a source/serving cell in order to trigger a RACH transmission in a candidate/target cell.

The techniques proposed herein may be used for beam and procedure selection when transmitting PRACH in candidate cells. The techniques may, thus, help facilitate a variety of different cell selection/mobility scenarios. For example, the techniques may be utilized in the candidate cell selection/mobility scenario illustrated in FIG. 5.

### Overview of Dynamic Signaling-Based Mobility

As noted above, dynamic mobility signaling (e.g., L1 and/or L2-centric mobility or LTM) may lead to more efficient intra-cell and inter-cell mobility with reduced latency.

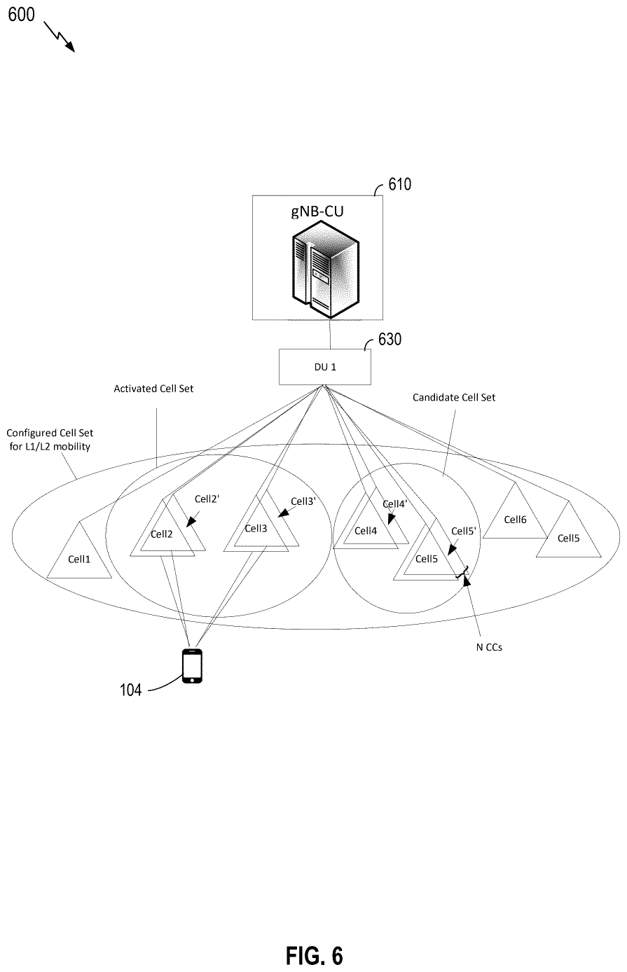

The general concept of LTM signaling may be understood with reference to the example scenario 600 shown in FIG. 6. As illustrated, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer. The network may also configure (signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

As in the example illustrated in FIG. 6, in some cases, all cells in the L1/L2 Mobility Configured cell set may belong to the same DU 630 of a CU 610. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

As illustrated in FIG. 6, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For PCell management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

In some cases, physical layer (Layer 1 or L1) measurement may be enhanced for L1/L2 mobility, where a serving cell can be changed via L1/L2 signalling based on L1 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management, may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

As noted above, a cell switch command MAC-CE may be sent by a source/serving cell in order to trigger a RACH transmission in a candidate/target cell. FIG. 7 depicts an example 700 of such a cell switch command MAC-CE triggered RACH transmission.

As noted above, for layer 1/2(L1/L2) triggered mobility (LTM), as a UE moves, a new serving cell may be selected (e.g., reselected) among a set of pre-configured candidate cells based on the UE's L1 measurement for those cells. To save timing advance (TA) acquisition time, a UE may send a physical random access channel (PRACH) to a target candidate cell for TA measurement before it is selected as a new serving cell.

PRACH triggering from the network entity may be based on a cell switch command MAC-CE, as illustrated in FIG. 7. For example, as shown, a current serving cell may transmit a cell switch command MAC-CE to a UE. As illustrated, the cell switch command MAC-CE may trigger the UE to transmit a PRACH to a candidate cell before it is selected as a new serving cell (e.g., in order to save TA acquisition time).

As illustrated at 702, the UE may participate in the PRACH procedure (e.g., transmit the PRACH) using a beam selected in accordance with the command (e.g., based on information present or absent in the command).

### Aspects Related to UE-Specific Cell Information Indication

Aspects of the present disclosure provide apparatuses, methods, processing systems, and computer-readable mediums for UE-specific cell information indication.

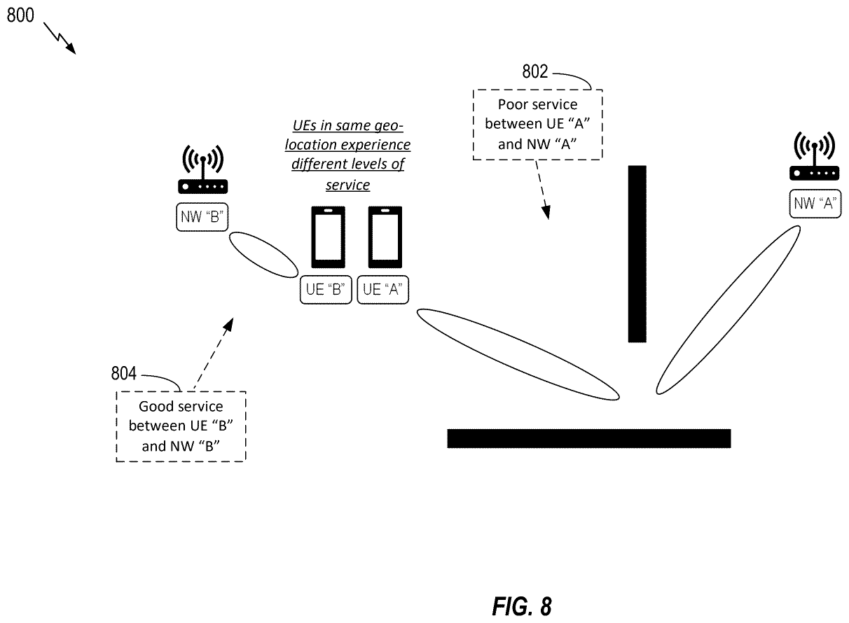

As noted above, in certain scenarios, UEs that are at the same geo-location may be connected to different networks and may experience different levels of service. For example, FIG. 8 depicts an example scenario 800 in which techniques for UE-specific cell information indication may be used, in accordance with certain aspects of the present disclosure.

As illustrated at 802, a specific UE (e.g., UE A), which is connected to network (NW) A, experiences poor service at a specific geo-location, while another UE (UE B), at the same geo-location, will experience good service (illustrated at 804) with its connection to NW B (e.g., where NW A and NW B may belong to the same/different operators).

The poor service experienced by UE A (with its connection to NW A) may be caused by, for example, distance of the UE to the NW, density of base station (e.g., gNB) deployment(s) of the NW, support for advanced features (e.g., physical downlink control channel (PDCCH) skipping/search space set group (SSSG) switching), which may impact energy consumption/latency) by the NW, interference from other cells, latency/delays (e.g., in response to uplink scheduling requests (SRs)), etc.

If NW A and NW B are operated by different providers, it might be beneficial if the owners of the UEs (e.g., assuming the owner of UE B is cooperative) would share information about the connection quality. Consequently, the owner of UE B can decide to switch to NW B if needed. Further, if NW A and NW B are operated by the same provider, UE A would ideally switch to NW B if it receives relevant information from UE B (on NW B). UE A would then use this information to improve cell/frequency selection. For example, UE A could prioritize searching and measuring high-score cells, perform cell (re)selection in idle/inactive states, execute conditional handover in connected mode, and decide which cells to report as part of its connected mode RRM measurement/report.

However, (owners of) UEs typically lack the tools to evaluate network quality and generally do not communicate with each other to consider feedback from neighbors for operator selection. Additionally, there is no mechanism for UEs to exchange connection information at the physical layer or application layers.

Aspects of the present disclosure, however, provide techniques that may enable UEs operating on different networks to share information about the connection quality observed by the UEs in their own network, as captured in metrics referred to herein as quality indicators (Qis). A UE may use this shared information (e.g., a list of QIs) for inter-network cell selection and reselection decisions (e.g., to switch between cells in different networks) and/or intra-network cell selection and reselection decisions (e.g., to switch between cells in the same network).

For example, aspects of the present disclosure may enable information exchange on the quality of the NW between the owners of the UEs without physical discussion between them, as well as without exposure of the personal information to maintain their privacy (e.g., if anonymity is preferred/required). Such techniques may also allowing the NW to get feedback(s) on itself and on its competitors. To accomplish this, aspects of the present disclosure define various “quality indicators” (QIs) related to a NW deployment, at given location and time and other parameters (e.g., frequency, bandwidth, and the like).

In accordance with the present disclosure, each UE may manage a database (e.g., obtain/gather/measure/calculate the QIs and maintain statistics), related to a full set (e.g., or a subset) of QIs (e.g., and optional ranking of NWs and/or reporting UEs), and then, periodically (e.g., or on demand) share them.

In some cases, the exchange of feedback/information may be managed by a server (e.g., a server dedicated to such a function) that will manage (e.g., collect and distribute) this information as a service or managed directly via UE to UE (sidelink) communications. This may enable any UE to, at various times, access a service that will provide “grades” “cores” of requested QI(s) for different NWs at any given location (e.g., subject to the availability of the data at the server).

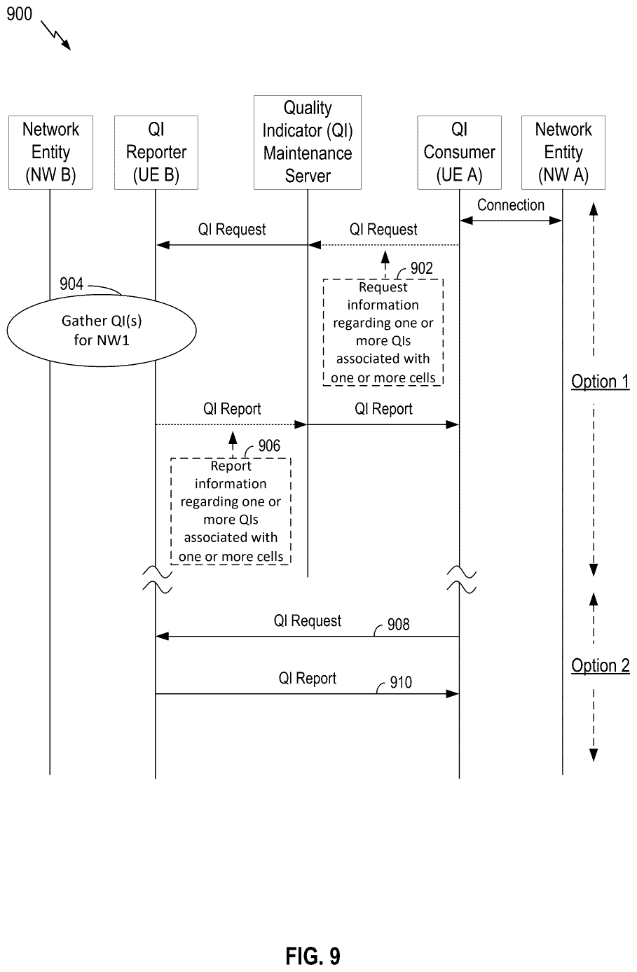

The signaling mechanisms for gathering and sharing Qis, in accordance with certain aspects of the present disclosure, may be understood with reference to the call flow diagram 900 of FIG. 9.

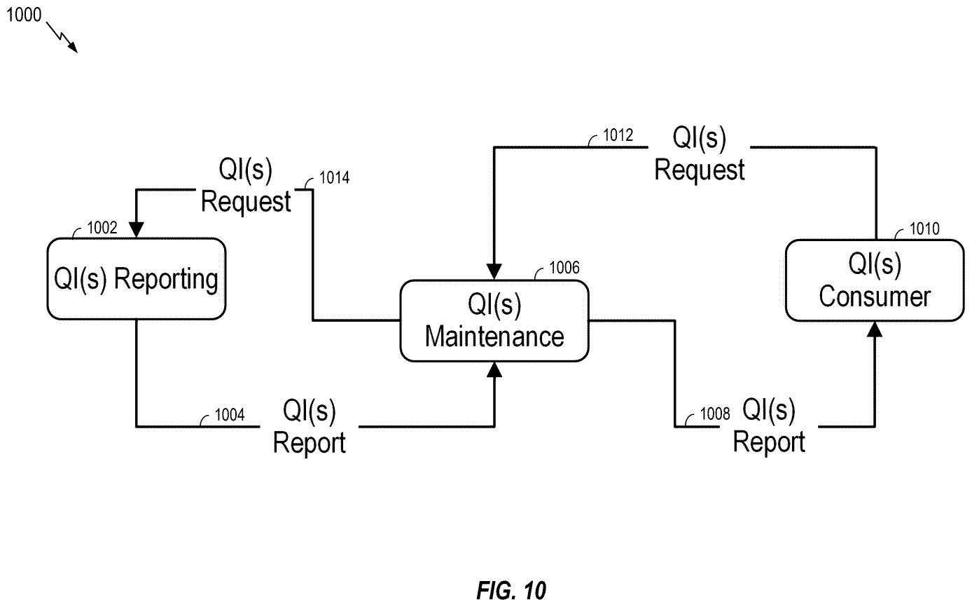

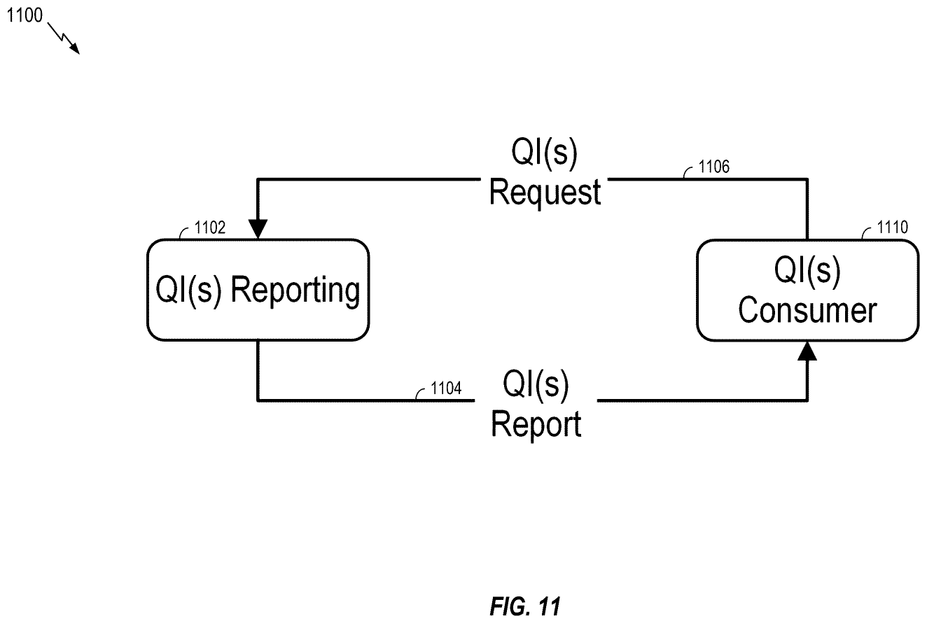

The UEs shown in FIG. 9 (and/or FIGS. 10-11) may be examples of the UE 104 depicted and described with respect to FIGS. 1 and 3. The network (NW) entities depicted in FIG. 9 (and/or FIGS. 10-11) may be examples of the BS 102 depicted and described with respect to FIGS. 1 and 3, or the disaggregated BS depicted and described with respect to FIG. 2.

As illustrated at 902, UE A (connected to NW A) may transmit a QI request, requesting information regarding one or more metrics (e.g., QIs) associated with one or more cells. As such, UE A may be considered (and referred to herein as) a QI consumer.

As illustrated, the QI request may be transmitted directly (sidelink) to UE B (connected to UE B), or may be transmitted to a dedicated server for QI maintenance. If the request is transmitted to the server, the server may transmit a QI request (e.g., or forward the received QI request) to the QI reporter. As such, UE B may be considered (and referred to herein as) a QI reporter.

As illustrated at 904, UE B may gather QI(s) for NW B (e.g., which may involve measuring signals from NW B, exchanging information with NW B, measuring latency associated with communications with NW B, etc.).

As illustrated at 906, UE B may transmit a QI report, reporting information regarding all, a subset of, or a superset of, the requested QIs. The operations described above with respect to 902-906 may be associated with a first option (Option 1), which involves a dedicated server for managing/maintaining QI/metrics, requests, and reporting.

As illustrated at 908 and 910, similar techniques may be used without involving a dedicated QI maintenance server, in accordance with a second option (Option 2). As illustrated at 908, for example, UE A may transmit a QI request directly (sidelink) to UE B. As illustrated at 910, UE B may provide a QI report directly to UE A.

As will be described in greater detail below, the operations described above with reference to call flow diagram 900 may also be performed in different sequences (e.g., or without a structured sequence).

For example, reporting UEs (such as UE B) may be configured to provide QI reports periodically, independent of QI requests or reports from other entities. Similarly, QI requests (e.g., from the server) may also be sent periodic, and/or may be sent independently of requests from other entities (e.g., QI consumers). Additionally, metrics/QIs may be gathered/obtained/calculated in response to a request, in preparation for transmitting a report, periodically, or otherwise independently of QI requests/reporting. In other words, a QI reporter may gather QIs according to one schedule and may report some or all of the QIs according to another schedule.

As used herein, Quality indicators (QIs), may refer, for example, to metrics/information regarding one or more of: delays in responses to scheduling requests (SRs) delays (e.g., latency), energy/power consumption, interference, capability/support for certain (e.g., advanced) features, signal to noise ratio (SNR), reference signal receive power (RSRP), received signal strength indicator (RSSI), maximum throughput, or average throughput.

As illustrated in FIG. 9, according to a first option (Option 1), a dedicated server may be used for QI maintenance (e.g., for managing QI data, QI requests, and QI reports). The server may be cloud-based, and may provide service using an application layer and/or a localized node (e.g., a Customer Premises Equipment (CPE)) that may exchange and manage the data using layers 1, 2, or 3 (L1-L3).

FIG. 10 depicts a diagram 1000 illustrating example techniques for UE-specific cell information indication including a dedicated server (Option 1), in accordance with certain aspects of the present disclosure.

As illustrated, a QI reporting entity (e.g., a UE) 1002 may transmit a QI report 1004 to a QI Maintenance server (e.g., a dedicated server) 1006. As illustrated, the QI Maintenance server may transmit a QI report 1008 to QI consumer 1010 (e.g., a UE). QI report 1008 may be the same or different from QI report 1004, and may be sent in response to or independently of QI report 1004.

As illustrated, QI consumer 1010 may transmit a QI request 1012 to the QI Maintenance server, which may transmit a QI request 1014 to the QI reporting entity. In some aspects, QI request 1014 may be transmitted in response to QI request 1012. QI request 1014 may be the same or different from QI request 1012. In some aspects, the timing of the transmissions illustrated in diagram 1000 may be independent of one another and/or may be periodic.

In some aspects, the server may send (e.g., using application or lower layers) to a “reporting UE”, a list of QIs that the server is interested in. This list may be provided as a recommendation and not as a command/obligation, as will be described in greater detail below. In some aspects, the server may indicate which QIs are more/less important/prioritized, which may reduce the load on the UE to send reports. In some aspects, such reports may be sent sparsely in time, as enough statistics may be aggregated by the reporting UE. However, the server may indicate certain periodicities and/or priorities.

The reporting UE may report (e.g., using application or lower layers) any of the QIs related to any NW to the dedicated server. The report may include the NW identification, time stamp, location of the UE, and a list of QIs with values or “scores” (e.g., normalized from 0 to 1) for each QI. In some aspects, the report may include a single “score” value which may be calculated based on each of (or a subset or a superset of) the individual QIs.

The mapping/calculation from QIs to a single score value may vary based on UE implementation, or it may follow a predetermined rule/function (e.g., which the UE may be configured with or which may be defined in certain standards specifications).

The report may also include UE related attributes, such as which cells/frequencies the UE has searched, which bands it support, which features it supports (e.g., capability information), its mobility state (e.g., whether it is moving fast or stationary, etc.). The NW identification may include identifying information related to a cell, gNB, public land mobile network (PLMN), etc. The list of QIs included may include one or more of the example QIs described above or any other QI not explicitly described herein. Reported QIs may not necessarily be limited to QIs indicated in the request.

In some cases, the reporting UE may be allowed to provide a report anonymously, or with varying amounts of exposure/anonymity. This may be beneficial in certain cases, such as when UE owners are willing to participate (opt-in) in such reporting by their UEs (e.g., to a server) only if explicit anonymity guarantees are provided (e.g., such that reports cannot be linked/traced to any UE identifier).

In some aspects, the server may receive the reports and manage statistics collected from all the UE-reported scores and/or QIs for each NW that had been reported on by at least one UE (e.g., for a given location and time). The server may also maintain context/memory of each contributing/reporting UE, which may be used to give weight to the UE's reports. In some aspects, for example, each UE may also have a score as a reporter/reviewer/contributor. For example, such a score may be based on how reliable a particular UE is and how much it has been contributing, and may be mapped to certain weights that are applied to each UEs reporting when determining a score for a particular NW. In some cases, service (e.g., cost of service and/or level of service) provided to UEs may be based on such a score indicating the reliability/contributions of the UE. Any information managed by the server may be based on current and/or historical data.

In some aspects, the requesting/consumer UE may request (e.g., using application or lower layers) a report from the server. The request may include, for example, a list of QIs that the requesting UE is interested in, as well as UE location (e.g., of the requesting UE or of the reporting UE), NW identification, and/or the time of interest (e.g., day/night/etc).

In some aspects, the list of the QIs could be defined by the (e.g., owner of the) UE or could be interpreted based on UE-defined priorities. For example, the (e.g., owner of the) UE may indicate priority for QIs/scores/information related to energy consumption and/or link coverage, etc. In some aspects, the requesting UE, the reporting UE, or the server could then map specific QIs that best represent the UEs owner's priorities/preferences. In some aspects, the request may specify a list of cells, frequencies, or frequency ranges for which QI/scores/information is requested. In some cases (e.g., when the trajectory of the UE mobility is known), the UE may share trajectory information and get relevant information about the cells along its trajectory.

The server may send the report (e.g., using application or lower layers) to the requesting UE (e.g., subject to the service the UE is eligible to get). For example, certain UEs (e.g., or any UEs who are acquiring the service from the dedicated server) could be eligible to get the report for free (e.g., if the service of the dedicated server is managed by a certain entity). The report may include the list of QIs that the requesting UE requested (e.g., or a subset or a superset, subject to data availability at the server) and/or their scores (e.g., normalized from 0 to 1). Alternatively, a single score value can be calculated based on the QIs of interest, and a weighted score can be reported to the UE. In some aspects, the report may include an ordered list of NWs, based on QIs of interest (e.g., with the NW with the best/highest score at the beginning of the list and the NW with the worst/lowest score at the end of the list).

FIG. 11 depicts a diagram 1100 illustrating example sidelink techniques (Option 2) for UE-specific cell information indication, in accordance with certain aspects of the present disclosure.

As illustrated, a QI reporting entity (e.g., a UE/QI Reporter) 1102 may transmit a QI report 1104 to QI Consumer 1110, which may transmit a QI request 1106. In some aspects, QI report 1104 may be transmitted in response to QI request 1106. In some aspects, however, the timing of any transmissions shown in diagram 1100 may be independent of one another, or may be periodic.

In some aspects, the requesting UE may transmit, directly to the neighbor UE(s) (e.g., sidelink), a request (e.g., using application or lower layers) for scores for or information regarding QIs of interest.

The reporting UE may report (e.g., using application or lower layers) such information (directly/sidelink) to the requesting UE. The report may include the list of QIs that the requesting UE is interested in (e.g., or a subset, or a superset, based on the available QIs at the reporting UE). Any information exchanged between UEs may be based on current and/or historical data.

The requesting UE may provide/calculate a score indicating a reliability of the reporting UE with regard to reporting. For example, such a score (e.g., normalized from 0 to 1) may be sent to the dedicated server and may be used for providing a collaborative cell scoring service. For example, the UEs which collaborate better with other UEs may get better service from the dedicated server.

In some cases (e.g., when the best NWs belong to other operators), the requesting UE may, based on the received scores/QIs of the other NWs, recommend to the (owner of the) UE to switch (or not) to the any other (better) NWs subject to the requested/available QIs. Such a recommendation may be indicated, for example, via a user interface (UI) or other mechanism.

In some cases (e.g., when the best NWs belong to the same operator), the UE may have (e.g., or be configured with) logic to consider reported information for multiple functions. For example, such logic may be used for cell/frequency selection, prioritizing search and measurement for high-grade cells, executing cell (re)selection in an idle/inactive state of conditional handovers in connect mode, deciding which cells to report as part of its connected mode RRM measurement/report, etc.

The use of additional (e.g., side) information in procedures like cell (re)selection or connected-mode measurement/mobility may be based on UE implementation or NW control/configuration. For example, certain standards specifications may specify that in order to expedite the cell selection process, stored information for several RATs, if available, may be used by the UE. In accordance with aspects of the present disclosure, such stored information may be extended to include additional/side information about QI acquired from another UE/server.

Explicit signaling may be used to allow the network to indicate that it is permissible for the UE to use the side information. Such an indication may be broadcast and applicable to all UEs, or may be provided in a dedicated manner (e.g., in an RRC message like RRC release/suspend) for a given UE. Such an indication may apply to all cells, a list of cells, an area (e.g., tracking area), or a configured time duration or period. In some aspects, such an indication may be more detailed than a simple 1-bit signal, and may include certain conditions for using the side information. For example, such an indication may include information regarding how the side information can be used (e.g., specifying if well-defined QIs are available, ranges and thresholds for QI and associated UE behavior), which types of QI may be used for a given process, and how much weight can be given to a QI.

In accordance with the present disclosure, any techniques described above with reference to Option 1 or Option 2 may be applied, where possible, to either option (or to other options consistent with the present disclosure). Option 1 and Option 2 are simply examples, and other options are possible in accordance with the present disclosure (e.g., utilizing sidelink communications in addition to a dedicated server for QI maintenance).

In accordance with the present disclosure, a wireless node (e.g., any UE or network entity such as an RU) may be both (or either) a QI reporter and a QI consumer, and may perform actions described herein as being performed by both QI reporters and QI consumers. In other words, a single wireless node (e.g., a UE) may perform the actions described above with respect to both UE A and UE B.

In some aspects, a network entity (e.g., an RU) may perform the actions described above as being performed by a UE. For example, an RU may request or report (e.g., from/to another network entity or a UE) information/metrics/QIs associated with a network (e.g., a DU).

In some aspects, a server may be implemented in/as/by a UE, and/or the actions described above as being performed by a server may be performed by a UE. For example, a relay UE may receive/transmit or forward requests and/or reports regarding metrics/QIs associated with a network.

Utilization of the techniques disclosed herein may help leverage statistics on the various quality indicators (QIs) that each UE device can gather to exchange information between UEs and increase the competition between various NW providers. Such techniques enable collaboration between UEs improve NW selection based on specific UE preferences, ultimately improving quality of service (QoS) and quality of experience (QoE).

### Example Operations

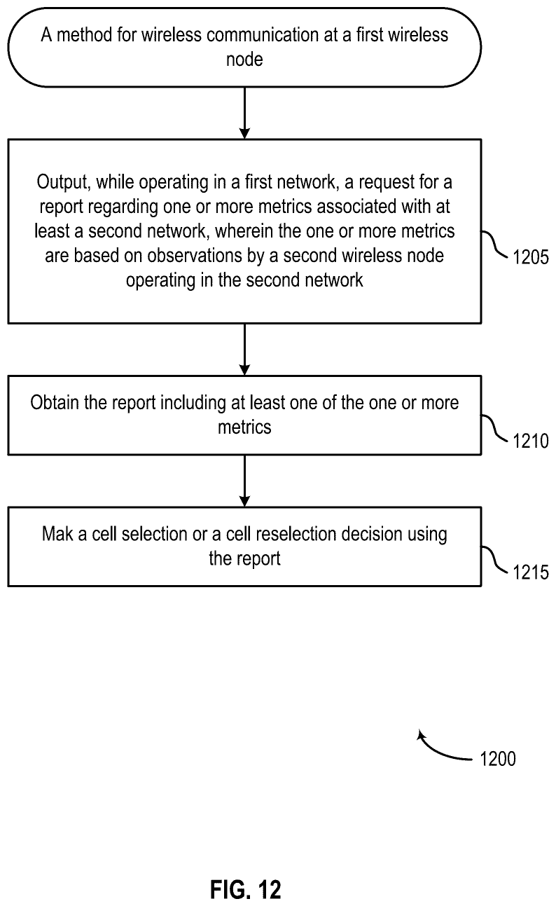

FIG. 12 shows an example of a method 1200 of wireless communication at a first wireless node. In some examples, the first wireless node is a user equipment, such as a UE 104 of FIGS. 1 and 3. In some examples, the first wireless node is a network entity, such as a BS 102 of FIGS. 1 and 3, or a disaggregated base station as discussed with respect to FIG. 2.

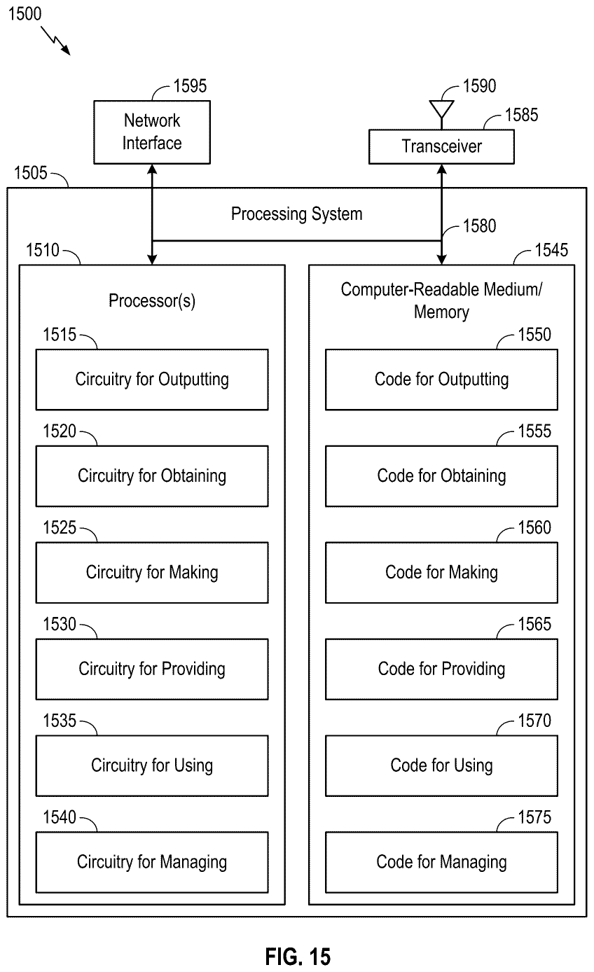

Method 1200 begins at step 1205 with outputting, while operating in a first network, a request for a report regarding one or more metrics associated with at least a second network, wherein the one or more metrics are based on observations by a second wireless node operating in the second network. In some cases, the operations of this step refer to, or may be performed by, circuitry for outputting and/or code for outputting as described with reference to FIG. 15.

Method 1200 then proceeds to step 1210 with obtaining the report including at least one of the one or more metrics. In some cases, the operations of this step refer to, or may be performed by, circuitry for obtaining and/or code for obtaining as described with reference to FIG. 15.

Method 1200 then proceeds to step 1215 with making a cell selection or a cell reselection decision using the report. In some cases, the operations of this step refer to, or may be performed by, circuitry for making and/or code for making as described with reference to FIG. 15.

In some aspects, the cell selection or cell reselection decision results in performing cell reselection involving moving from a cell in the first network to a cell in the second network.

In some aspects, the first network and second network are associated with different operators and the report is used to make an inter-network cell selection or cell reselection decision; or the first network and second network are associated with a same operator and the report is used to make an intra-network cell selection or cell reselection decision.

In some aspects, the report regarding one or more metrics includes information regarding at least one of: latency, energy consumption, interference, support of certain features, signal to noise ratio (SNR), reference signal receive power (RSRP), received signal strength indicator (RSSI), or throughput.

In some aspects, the request is output to a server; and the report is obtained from the server.

In some aspects, the report includes at least one of: an individual score for one or more of the one or more metrics based on observations by the second wireless node operating in the second network; or an aggregate score based on multiple of the one or more metrics based on observations by the second wireless node operating in the second network.

In some aspects, the request indicates at least one of: a list of the one or more metrics; a location of the first wireless node; an identify of the second network; a time of interest for the one or more metrics; one or more priorities of the first wireless node; a list of one or more cells, frequencies, or frequency ranges; or information regarding a trajectory of the first wireless node.

In some aspects, the request indicates the report is for one or more metrics associated with multiple networks including the second network and at least a third network; and the one or more metrics for the multiple networks are ordered in the report, per network, based on individual metric values or aggregated metric values.

In some aspects, the method 1200 further includes providing, to a user of the first wireless node, a recommendation to: switch to the second network, or switch, within the first network, from a first cell to a second cell. In some cases, the operations of this step refer to, or may be performed by, circuitry for providing and/or code for providing as described with reference to FIG. 15.

In some aspects, the method 1200 further includes using the report to at least one of: perform cell selection, perform frequency selection, prioritize search, prioritize measurement, perform cell reselection, or decide what cells to include for measurement reporting. In some cases, the operations of this step refer to, or may be performed by, circuitry for using and/or code for using as described with reference to FIG. 15.

In some aspects, the request is output to the second wireless node; and the report is obtained from the second wireless node.

In some aspects, the method 1200 further includes outputting an indication, to a server, of a score related to the second wireless node. In some cases, the operations of this step refer to, or may be performed by, circuitry for outputting and/or code for outputting as described with reference to FIG. 15.

In some aspects, the method 1200 further includes obtaining an indication, from a second wireless node, indicating the first wireless node is authorized to use the report to make the cell selection or the cell reselection. In some cases, the operations of this step refer to, or may be performed by, circuitry for obtaining and/or code for obtaining as described with reference to FIG. 15.

In some aspects, the report includes a list of the metrics.

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

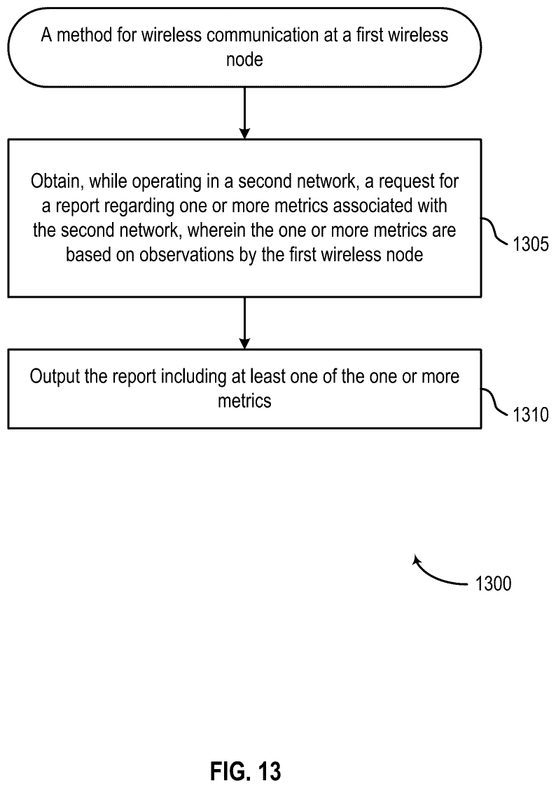

FIG. 13 shows an example of a method 1300 of wireless communication at a first wireless node. In some examples, the first wireless node is a user equipment, such as a UE 104 of FIGS. 1 and 3. In some examples, the first wireless node is a network entity, such as a BS 102 of FIGS. 1 and 3, or a disaggregated base station as discussed with respect to FIG. 2.

Method 1300 begins at step 1305 with obtaining, while operating in a second network, a request for a report regarding one or more metrics associated with the second network, wherein the one or more metrics are based on observations by the first wireless node. In some cases, the operations of this step refer to, or may be performed by, circuitry for obtaining and/or code for obtaining as described with reference to FIG. 15.

Method 1300 then proceeds to step 1310 with outputting the report including at least one of the one or more metrics. In some cases, the operations of this step refer to, or may be performed by, circuitry for outputting and/or code for outputting as described with reference to FIG. 15.

In some aspects, the report regarding one or more metrics includes information regarding at least one of: latency, energy consumption, interference, support of certain features, signal to noise ratio (SNR), reference signal receive power (RSRP), received signal strength indicator (RSSI), or throughput.

In some aspects, the request is obtained from a server and the report is output to the server; or the request is obtained from a second wireless node, operating in a first network, and the report is output to the second wireless node.

In some aspects, the request indicates one or more priorities for the one or more metrics; and the at least one of the one or more metrics included in the report are based on the one or more priorities.

In some aspects, the report indicates at least one of: an identification of the second network; a time stamp or time duration; or a location of the first wireless node.

In some aspects, the report lacks an identity associated with the first wireless node.

In some aspects, the request indicates at least one of: a list of the one or more metrics; a location of the second wireless node; an identify of the second network; a time of interest for the one or more metrics; one or more priorities of the second wireless node; a list of one or more cells, frequencies, or frequency ranges; or information regarding a trajectory of the second wireless node.

In some aspects, the report includes at least one of: an individual score for one or more of the one or more metrics based on observations by the first wireless node; or an aggregate score based on multiple of the one or more metrics based on observations by the first wireless node.

In some aspects, the request indicates the report is for one or more metrics associated with multiple networks including the second network and at least a third network; and the one or more metrics for the multiple networks are ordered in the report, per network, based on individual metric values or aggregated metric values.

In some aspects, the report includes a list of the metrics.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

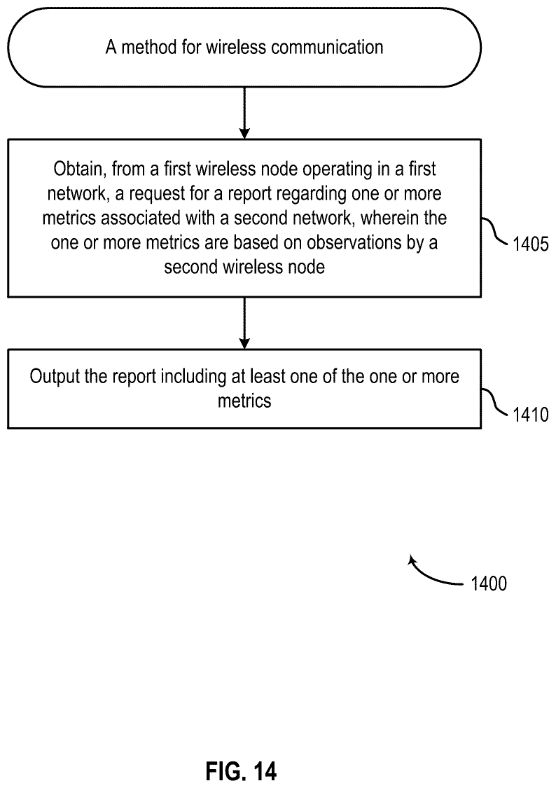

FIG. 14 shows an example of a method 1400 of wireless communication at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

Method 1400 begins at step 1405 with obtaining, from a first wireless node operating in a first network, a request for a report regarding one or more metrics associated with a second network, wherein the one or more metrics are based on observations by a second wireless node. In some cases, the operations of this step refer to, or may be performed by, circuitry for obtaining and/or code for obtaining as described with reference to FIG. 15.

Method 1400 then proceeds to step 1410 with outputting the report including at least one of the one or more metrics. In some cases, the operations of this step refer to, or may be performed by, circuitry for outputting and/or code for outputting as described with reference to FIG. 15.

In some aspects, the report regarding one or more metrics includes information regarding at least one of: latency, energy consumption, interference, support of certain features, signal to noise ratio (SNR), reference signal receive power (RSRP), received signal strength indicator (RSSI), or throughput.

In some aspects, the request indicates one or more priorities for the one or more metrics; and the at least one of the one or more metrics included in the report are based on the one or more priorities.

In some aspects, the report indicates at least one of: an identification of the second network; a time stamp or time duration; or a location of the second wireless node.

In some aspects, the report lacks an identity associated with the second wireless node.

In some aspects, the method 1400 further includes obtaining reports, from multiple wireless nodes, regarding one or more metrics associated with one or more networks, wherein the one or more metrics are based on observations by the multiple wireless nodes. In some cases, the operations of this step refer to, or may be performed by, circuitry for obtaining and/or code for obtaining as described with reference to FIG. 15.

In some aspects, the method 1400 further includes managing the metrics obtained in the reports. In some cases, the operations of this step refer to, or may be performed by, circuitry for managing and/or code for managing as described with reference to FIG. 15.

In some aspects, the request indicates at least one of: a list of the one or more metrics; a location of the first wireless node; an identify of the second network; a time of interest for the one or more metrics; one or more priorities of the first wireless node; a list of one or more cells, frequencies, or frequency ranges; or information regarding a trajectory of the first wireless node.

In some aspects, the report includes at least one of: an individual score for one or more of the one or more metrics based on observations by the second wireless node; or an aggregate score based on multiple of the one or more metrics based on observations by the second wireless node.

In some aspects, the request indicates the report is for one or more metrics associated with multiple networks including the second network and at least a third network; and the one or more metrics for the multiple networks are ordered in the report, per network, based on individual metric values or aggregated metric values.

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 14 is just one example of a method, and other methods including fewer, additional, or alternative steps are possible consistent with this disclosure.

### Example Communications Device(s)

FIG. 15 depicts aspects of an example communications device 1500. In some aspects, communications device 1500 is a user equipment, such as UE 104 described above with respect to FIGS. 1 and 3. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1585 (e.g., a transmitter and/or a receiver). In some aspects (e.g., when communications device 1500 is a network entity), processing system 1505 may be coupled to a network interface 1595 that is configured to obtain and send signals for the communications device 1500 via communication link(s), such as a backhaul link, midhaul link, and/or fronthaul link as described herein, such as with respect to FIG. 2. The transceiver 1585 is configured to transmit and receive signals for the communications device 1500 via the antenna 1590, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1545 via a bus 1580. In certain aspects, the computer-readable medium/memory 1545 is configured to store instructions (e.g., computer-executable code) that when executed by the one or more processors 1510, cause the one or more processors 1510 to perform the method 1200 described with respect to FIG. 12, or any aspect related to it; the method 1300 described with respect to FIG. 13, or any aspect related to it; and the method 1400 described with respect to FIG. 14, or any aspect related to it. Note that reference to a processor performing a function of communications device 1500 may include one or more processors 1510 performing that function of communications device 1500.

In the depicted example, computer-readable medium/memory 1545 stores code (e.g., executable instructions), such as code for outputting 1550, code for obtaining 1555, code for making 1560, code for providing 1565, code for using 1570, and code for managing 1575. Processing of the code for outputting 1550, code for obtaining 1555, code for making 1560, code for providing 1565, code for using 1570, and code for managing 1575 may cause the communications device 1500 to perform the method 1200 described with respect to FIG. 12, or any aspect related to it; the method 1300 described with respect to FIG. 13, or any aspect related to it; and the method 1400 described with respect to FIG. 14, or any aspect related to it.

The one or more processors 1510 include circuitry configured to implement (e.g., execute) the code stored in the computer-readable medium/memory 1545, including circuitry for outputting 1515, circuitry for obtaining 1520, circuitry for making 1525, circuitry for providing 1530, circuitry for using 1535, and circuitry for managing 1540. Processing with circuitry for outputting 1515, circuitry for obtaining 1520, circuitry for making 1525, circuitry for providing 1530, circuitry for using 1535, and circuitry for managing 1540 may cause the communications device 1500 to perform the method 1200 described with respect to FIG. 12, or any aspect related to it; the method 1300 described with respect to FIG. 13, or any aspect related to it; and the method 1400 described with respect to FIG. 14, or any aspect related to it.

Various components of the communications device 1500 may provide means for performing the method 1200 described with respect to FIG. 12, or any aspect related to it; the method 1300 described with respect to FIG. 13, or any aspect related to it; and the method 1400 described with respect to FIG. 14, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1585 and the antenna 1590 of the communications device 1500 in FIG. 15. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1585 and the antenna 1590 of the communications device 1500 in FIG. 15.

### EXAMPLE CLAUSES

Implementation examples are described in the following numbered clauses:

Clause 1: A method for wireless communication at a first wireless node, comprising: outputting, while operating in a first network, a request for a report regarding one or more metrics associated with at least a second network, wherein the one or more metrics are based on observations by a second wireless node operating in the second network; obtaining the report including at least one of the one or more metrics; and making a cell selection or a cell reselection decision using the report.

Clause 2: The method of Clause 1, wherein the cell selection or cell reselection decision results in performing cell reselection involving moving from a cell in the first network to a cell in the second network.

Clause 3: The method of Clause 2, wherein: the first network and second network are associated with different operators and the report is used to make an inter-network cell selection or cell reselection decision; or the first network and second network are associated with a same operator and the report is used to make an intra-network cell selection or cell reselection decision.

Clause 4: The method of any one of Clauses 1-3, wherein the report regarding one or more metrics includes information regarding at least one of: latency, energy consumption, interference, support of certain features, signal to noise ratio (SNR), reference signal receive power (RSRP), received signal strength indicator (RSSI), or throughput.

Clause 5: The method of any one of Clauses 1-4, wherein: the request is output to a server; and the report is obtained from the server.

Clause 6: The method of any one of Clauses 1-5, wherein the request indicates at least one of: a list of the one or more metrics; a location of the first wireless node; an identify of the second network; a time of interest for the one or more metrics; one or more priorities of the first wireless node; a list of one or more cells, frequencies, or frequency ranges; or information regarding a trajectory of the first wireless node.

Clause 7: The method of Clause 5, wherein the report includes at least one of: an individual score for one or more of the one or more metrics based on observations by the second wireless node operating in the second network; or an aggregate score based on multiple of the one or more metrics based on observations by the second wireless node operating in the second network.

Clause 8: The method of any one of Clauses 1-7, wherein: the request indicates the report is for one or more metrics associated with multiple networks including the second network and at least a third network; and the one or more metrics for the multiple networks are ordered in the report, per network, based on individual metric values or aggregated metric values.

Clause 9: The method of any one of Clauses 1-8, further comprising providing, to a user of the first wireless node, a recommendation to: switch to the second network, or switch, within the first network, from a first cell to a second cell.

Clause 10: The method of any one of Clauses 1-9, further comprising using the report to at least one of: perform cell selection, perform frequency selection, prioritize search, prioritize measurement, perform cell reselection, or decide what cells to include for measurement reporting.

Clause 11: The method of any one of Clauses 1-10, wherein: the request is output to the second wireless node; and the report is obtained from the second wireless node.

Clause 12: The method of any one of Clauses 1-11, wherein the report includes a list of the metrics.

Clause 13: The method of Clause 11, further comprising outputting an indication, to a server, of a score related to the second wireless node.

Clause 14: The method of Clause 11, further comprising obtaining an indication, from a second wireless node, indicating the first wireless node is authorized to use the report to make the cell selection or the cell reselection.

Clause 15: A method for wireless communication at a first wireless node, comprising: obtaining, while operating in a second network, a request for a report regarding one or more metrics associated with the second network, wherein the one or more metrics are based on observations by the first wireless node; and outputting the report including at least one of the one or more metrics.

Clause 16: The method of Clause 15, wherein the report regarding one or more metrics includes information regarding at least one of: latency, energy consumption, interference, support of certain features, signal to noise ratio (SNR), reference signal receive power (RSRP), received signal strength indicator (RSSI), or throughput.

Clause 17: The method of any one of Clauses 15-16, wherein: the request is obtained from a server and the report is output to the server; or the request is obtained from a second wireless node, operating in a first network, and the report is output to the second wireless node.

Clause 18: The method of any one of Clauses 15-17, wherein: the request indicates one or more priorities for the one or more metrics; and the at least one of the one or more metrics included in the report are based on the one or more priorities.

Clause 19: The method of any one of Clauses 15-18, wherein the report indicates at least one of: an identification of the second network; a time stamp or time duration; or a location of the first wireless node.

Clause 20: The method of any one of Clauses 15-19, wherein the report lacks an identity associated with the first wireless node.

Clause 21: The method of any one of Clauses 15-20, wherein the request indicates at least one of: a list of the one or more metrics; a location of the second wireless node; an identify of the second network; a time of interest for the one or more metrics; one or more priorities of the second wireless node; a list of one or more cells, frequencies, or frequency ranges; or information regarding a trajectory of the second wireless node.

Clause 22: The method of Clause 21, wherein the report includes at least one of: an individual score for one or more of the one or more metrics based on observations by the first wireless node; or an aggregate score based on multiple of the one or more metrics based on observations by the first wireless node.

Clause 23: The method of any one of Clauses 15-22, wherein: the request indicates the report is for one or more metrics associated with multiple networks including the second network and at least a third network; and the one or more metrics for the multiple networks are ordered in the report, per network, based on individual metric values or aggregated metric values.

Clause 24: The method of any one of Clauses 15-23, wherein the report includes a list of the metrics.

Clause 25: A method for wireless communication, comprising: obtaining, from a first wireless node operating in a first network, a request for a report regarding one or more metrics associated with a second network, wherein the one or more metrics are based on observations by a second wireless node; and outputting the report including at least one of the one or more metrics.

Clause 26: The method of Clause 25, wherein the report regarding one or more metrics includes information regarding at least one of: latency, energy consumption, interference, support of certain features, signal to noise ratio (SNR), reference signal receive power (RSRP), received signal strength indicator (RSSI), or throughput.

Clause 27: The method of any one of Clauses 25-26, wherein: the request indicates one or more priorities for the one or more metrics; and the at least one of the one or more metrics included in the report are based on the one or more priorities.

Clause 28: The method of any one of Clauses 25-27, wherein the report indicates at least one of: an identification of the second network; a time stamp or time duration; or a location of the second wireless node.

Clause 29: The method of any one of Clauses 25-28, wherein the report lacks an identity associated with the second wireless node.

Clause 30: The method of any one of Clauses 25-29, further comprising: obtaining reports, from multiple wireless nodes, regarding one or more metrics associated with one or more networks, wherein the one or more metrics are based on observations by the multiple wireless nodes; and managing the metrics obtained in the reports.

Clause 31: The method of any one of Clauses 25-30, wherein the request indicates at least one of: a list of the one or more metrics; a location of the first wireless node; an identify of the second network; a time of interest for the one or more metrics; one or more priorities of the first wireless node; a list of one or more cells, frequencies, or frequency ranges; or information regarding a trajectory of the first wireless node.

Clause 32: The method of Clause 31, wherein the report includes at least one of: an individual score for one or more of the one or more metrics based on observations by the second wireless node; or an aggregate score based on multiple of the one or more metrics based on observations by the second wireless node.

Clause 33: The method of any one of Clauses 25-32, wherein: the request indicates the report is for one or more metrics associated with multiple networks including the second network and at least a third network; and the one or more metrics for the multiple networks are ordered in the report, per network, based on individual metric values or aggregated metric values.

Clause 34: An apparatus, comprising: at least one memory comprising executable instructions; and at least one processor configured to execute the executable instructions and cause the apparatus to perform a method in accordance with any combination of Clauses 1-33.

Clause 35: An apparatus, comprising means for performing a method in accordance with any combination of Clauses 1-33.

Clause 36: A non-transitory computer-readable medium comprising executable instructions that, when executed by at least one processor of an apparatus, cause the apparatus to perform a method in accordance with any combination of Clauses 1-33.

Clause 37: A computer program product embodied on a computer-readable storage medium comprising code for performing a method in accordance with any combination of Clauses 1-33.

Clause 38: A wireless node (e.g., a UE), comprising: at least one transceiver, at least one memory comprising instructions; and at least one processor configured to execute the instructions and cause the apparatus to perform a method in accordance with any combination of Clauses 1-14, wherein the at least one transceiver configured to transmit the request and receive the report.

Clause 39: A wireless node (e.g., a UE) or a network entity such as an RU), comprising: at least one transceiver, at least one memory comprising instructions; and at least one processor configured to execute the instructions and cause the apparatus to perform a method in accordance with any combination of Clauses 15-24, wherein the at least one transceiver configured to receive the request and transmit the report.

Clause 40: A wireless node (e.g., a network entity implementing or acting as a server), comprising: at least one transceiver, at least one memory comprising instructions; and at least one processor configured to execute the instructions and cause the apparatus to perform a method in accordance with any combination of Clauses 25-33, wherein the at least one transceiver configured to receive the request and transmit the report.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for outputting, means for obtaining, means for making, means for providing, means for using, means for providing, means for performing, means for moving, and means for managing may comprise one or more processors, such as one or more of the processors described above with reference to FIG. 15.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions to cause the apparatus to:
output, while operating in a first network, a request for a report regarding one or more metrics associated with at least a second network, wherein the one or more metrics are based on observations by a wireless node operating in the second network;
obtain the report including at least one of the one or more metrics; and
make a cell selection or a cell reselection decision using the report.

2. The apparatus of claim 1, wherein the cell selection or cell reselection decision results in performing cell reselection involving moving from a cell in the first network to a cell in the second network.

3. The apparatus of claim 2, wherein:
the first network and second network are associated with different operators and the report is used to make an inter-network cell selection or cell reselection decision; or
the first network and second network are associated with a same operator and the report is used to make an intra-network cell selection or cell reselection decision.

4. The apparatus of claim 1, wherein the report regarding one or more metrics includes information regarding at least one of: latency, energy consumption, interference, support of certain features, signal to noise ratio (SNR), reference signal receive power (RSRP), received signal strength indicator (RSSI), or throughput.

5. The apparatus of claim 1, wherein:
the request is output to a server; and
the report is obtained from the server.

6. The apparatus of claim 1, wherein the request indicates at least one of:
a list of the one or more metrics;
a location of the apparatus;
an identify of the second network;
a time of interest for the one or more metrics;
one or more priorities of the apparatus;
a list of one or more cells, frequencies, or frequency ranges; or
information regarding a trajectory of the apparatus.

7. The apparatus of claim 5, wherein the report includes at least one of:
an individual score for one or more of the one or more metrics based on observations by the wireless node operating in the second network; or
an aggregate score based on multiple of the one or more metrics based on observations by the wireless node operating in the second network.

8. The apparatus of claim 1, wherein:
the request indicates the report is for one or more metrics associated with multiple networks including the second network and at least a third network; and
the one or more metrics for the multiple networks are ordered in the report, per network, based on individual metric values or aggregated metric values.

9. The apparatus of claim 1, wherein:
the one or more processors are further configured to cause the apparatus to provide, to a user of the apparatus, a recommendation to:
switch to the second network; or
switch, within the first network, from a first cell to a second cell.

10. The apparatus of claim 1, wherein:
the one or more processors are further configured to cause the apparatus to use the report to at least one of: perform cell selection, perform frequency selection, prioritize search, prioritize measurement, perform cell reselection, or decide what cells to include for measurement reporting.

11. The apparatus of claim 1, wherein:
the request is output to the wireless node; and
the report is obtained from the wireless node.

12. The apparatus of claim 1, wherein the report includes a list of the metrics.

13. The apparatus of claim 11, wherein
the one or more processors are further configured to cause the apparatus to output an indication, to a server, of a score related to the wireless node.

14. The apparatus of claim 11, wherein:
the one or more processors are further configured to cause the apparatus to obtain an indication, from a wireless node, indicating the apparatus is authorized to use the report to make the cell selection or the cell reselection.

15. The apparatus of claim 1, further comprising at least one transceiver configured to transmit the request and receive the report, wherein the apparatus is configured as a user equipment (UE).

16. An apparatus for wireless communication, comprising:
at least one memory comprising computer-executable instructions; and
one or more processors configured to execute the computer-executable instructions to cause the apparatus to:
obtain, while operating in a second network, a request for a report regarding one or more metrics associated with the second network, wherein the one or more metrics are based on observations by the apparatus; and
output the report including at least one of the one or more metrics.

17. The apparatus of claim 16, wherein the report regarding one or more metrics includes information regarding at least one of: latency, energy consumption, interference, support of certain features, signal to noise ratio (SNR), reference signal receive power (RSRP), received signal strength indicator (RSSI), or throughput.

18. The apparatus of claim 16, wherein:
the request is obtained from a server and the report is output to the server; or
the request is obtained from a wireless node, operating in a first network, and the report is output to the wireless node.

19. The apparatus of claim 16, further comprising at least one transceiver configured to receive the request and transmit the report, wherein the apparatus is configured as a user equipment (UE).

20. An apparatus for wireless communication, comprising:
at least one memory comprising computer-executable instructions; and
one or more processors configured to execute the computer-executable instructions to cause the apparatus to:
obtain, from a first wireless node operating in a first network, a request for a report regarding one or more metrics associated with a second network, wherein the one or more metrics are based on observations by a second wireless node; and
output the report including at least one of the one or more metrics.
